(19) United States
(12) Patent Application Publication
(10) Pub. No.: US 2025/0275496 A1
(43) Pub. Date: Sep. 4, 2025

(54) INDEPENDENT WING POSITION CONTROL FOR AN AGRICULTURAL IMPLEMENT

(71) Applicant: CNH Industrial America LLC, New Holland, PA (US)

(72) Inventors: Timothy Richard Blunier, North Danvers, IL (US); Heath A. Toennies, Eureka, IL (US); Sven Nathaniel Setterdahl, Maquon, IL (US); Brice Magarity, Deer Creek, IL (US)

(21) Appl. No.: 18/591,505

(22) Filed: Feb. 29, 2024

(51) Int. Cl. A01B 63/22; A01B 63/32

(52) U.S. Cl. CPC A01B 63/22; A01B 63/32

(57) ABSTRACT

Present embodiments disclose a height adjustment system for an agricultural implement that includes a main lift cylinder configured to control a vertical position of a center section wheel assembly, such that the center section wheel assembly is movably coupled to a center section of a frame of the agricultural implement, and a wing lift cylinder configured to control a vertical position of a wing section wheel assembly, such that the wing section wheel assembly is movably coupled to a wing section of the frame of the agricultural implement. Additionally, the height adjustment system for the agricultural implement includes a hydraulic circuit that includes a main lift metering valve configured to control hydraulic fluid flow to and from the main lift cylinder and the wing lift cylinder to control the vertical position of the center section wheel assembly and the vertical position of the wing section wheel assembly in unison.

### BACKGROUND

The present disclosure relates generally to independent wing position control for an agricultural implement.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Certain agricultural implements include ground-engaging tools configured to interact with soil. For example, a tillage implement is an agricultural implement that may include multiple disc blades configured to break up the soil for subsequent planting and/or seeding operations. In operation, the tillage implement is coupled to a towing vehicle, such as a tractor, and as the tillage implement is towed behind the towing vehicle, the tillage implement prepares the soil by way of mechanical agitation. The disc blades may be arranged in groups, such as gangs, and coupled to a frame of the tillage implement in a configuration suitable for mechanically agitating the soil throughout a suitable penetration depth.

However, due to certain factors (e.g., uneven terrain, soil conditions, variable crop residue layers, etc.), the ground-engaging tools (e.g., disc blades) of the tillage implement may not suitably penetrate the soil to a desired penetration depth. For example, while towing the implement, an operator may notice that a portion of the tillage implement is tilling the soil at a different depth from an adjacent portion of the tillage implement. Uneven and variable soil tillage may lead to inconsistent soil conditions, which may result in inconsistent crop yield.

### BRIEF DESCRIPTION

This summary is provided to introduce a selection of concepts that are further described below in the detailed description. This summary is not intended to identify key or essential features of the claimed subject matter, nor is it intended to be used as an aid in limiting the scope of the claimed subject matter.

In certain embodiments, a height adjustment system for an agricultural implement includes a main lift cylinder configured to control a vertical position of a center section wheel assembly, such that the center section wheel assembly is movably coupled to a center section of a frame of the agricultural implement, and a wing lift cylinder configured to control a vertical position of a wing section wheel assembly, such that the wing section wheel assembly is movably coupled to a wing section of the frame of the agricultural implement. Additionally, the height adjustment system for the agricultural implement includes a hydraulic circuit that includes a main lift metering valve configured to control hydraulic fluid flow to and from the main lift cylinder and the wing lift cylinder to control the vertical position of the center section wheel assembly and the vertical position of the wing section wheel assembly in unison, and a wing control valve circuit that includes a first control valve, such that the first control valve is configured to control fluid flow to and from the wing lift cylinder to control the vertical position of the wing section wheel assembly independently of the center section wheel assembly.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having a height adjustment system, in accordance with aspects of the present disclosure;

FIG. 2 is a schematic view of an embodiment of a height adjustment system that may be employed within the agricultural implement of FIG. 1, in accordance with aspects of the present disclosure; and

FIG. 3 is a schematic view of an embodiment of a hydraulic circuit that may be employed within the height adjustment system of FIG. 2, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Farmers utilize a wide variety of agricultural equipment in order to prepare fields for subsequent agricultural operations. For example, a top layer of soil may be prepared for subsequent seeding or planting operations. To prepare the top layer of the soil, a tillage implement with a center section and multiple wing sections may be towed through a field by a work vehicle, such as a tractor. Ground-engaging tools (e.g., disc blades) are coupled to the center section and each wing section. Maintaining a suitably consistent penetration depth of the ground-engaging tools establishes consistent mechanical soil agitation throughout the field, thereby providing consistent crop yield after the subsequent seeding or planting operations. However, as the tillage implement is towed through the field, the ground-engaging tools of one of the sections (e.g., center section, left wing section, right wing section, etc.) may interact with the top layer of soil at a different penetration depth than the ground-engaging tools of neighboring sections.

Present embodiments are directed to facilitating and improving a tillage implement height adjustment system. For example, present embodiments include individual hydraulic control valve circuits corresponding to an individual section of the agricultural implement. These individual hydraulic control valve circuits may include control valves that are configured to enable a control system or an operator to independently adjust a vertical position of individual sections of the agricultural implement, in relation to a frame or the top layer of the soil. The control valves may be a portion of a hydraulic circuit, and may be fluidly coupled to a hydraulic cylinder, which in turn may be coupled to a wheel assembly. By introducing hydraulic fluid through the hydraulic circuit, the operator or control system may adjust the vertical position of the agricultural implement as an entire unit in unison, while also independently adjusting the vertical position of individual sections of the implement.

Present embodiments provide a user interface and display that enables the operator to input adjustments to the vertical positions of the individual sections of the implement. For example, the control system may be configured to communicatively couple with sensors on the individual sections of the implement, and enable the operator to adjust the vertical position of the individual sections of the implement based on the sensor feedback. By utilizing the control system and its components, the user may adjust the vertical position of individual sections of the implement during operation, thereby enabling consistent penetration depth by mechanical agitation tools coupled to each section of the implement. By utilizing the present embodiments of the implement height adjustment system, agricultural operations are made more efficient.

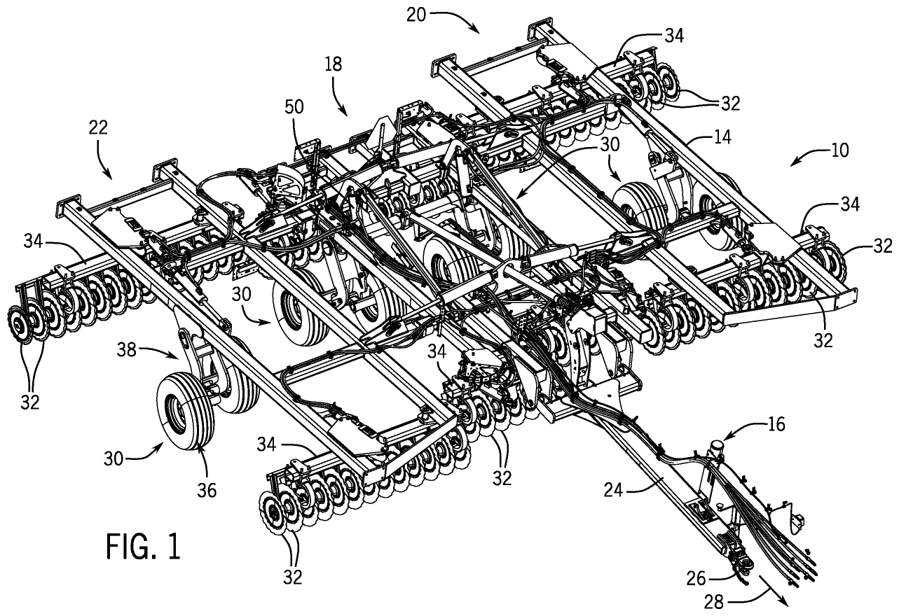

FIG. 1 is a perspective view of an embodiment of an agricultural implement (e.g., tillage implement) 10 having a height adjustment system 50. In the illustrated embodiment, the agricultural implement is a tillage implement 10 (e.g., vertical tillage implement) having multiple ground-engaging tools configured to till soil. As discussed in further detail below, the height adjustment system 50 includes various hydraulic components and a control system that enables a user to adjust a vertical position of the tillage implement 10 during operation. As illustrated, the tillage implement 10 includes a frame 14 and a hitch assembly 16 coupled to the frame 14. In the illustrated embodiment, the frame 14 includes a center section 18, a left wing section 20, and a right wing section 22. Each wing section is configured to rotate upwardly from the illustrated working position to a transport position to facilitate transport of the tillage implement 10. For example, one or more actuators (e.g. hydraulic cylinder(s), etc.) may be configured to drive each wing section to rotate between the illustrated working position and the transport position. While the frame 14 includes the center section 18, the left wing section 20, and the right wing section 22 in the illustrated embodiment, in other embodiments, the frame may include more or fewer sections. Furthermore, the frame 14 may be formed from multiple frame elements (e.g., rails, tubes, braces, etc.) coupled to one another (e.g., via welded connection(s), via fastener(s), etc.).

In the illustrated embodiment, the hitch assembly 16 includes a hitch frame 24 and a hitch 26. The hitch frame 24 is pivotally coupled to the implement frame 14 via pivot joint(s), and the hitch 26 is configured to couple to a corresponding hitch of a work vehicle (e.g. tractor), which is configured to tow the tillage implement 10 through a field along a direction of travel 28. While the hitch frame 24 is pivotally coupled to the implement frame 14 in the illustrated embodiment, in other embodiments, the hitch frame may be movably coupled to the implement frame by a linkage assembly (e.g. four bar linkage assembly, etc.) or another suitable assembly/mechanism that enables the hitch to move along a vertical axis relative to the implement frame, or the hitch frame may be rigidly coupled to the implement frame.

As illustrated, the tillage implement 10 includes wheel assemblies 30 movably coupled to the implement frame 14. In the illustrated embodiment, each wheel assembly 30 includes a wheel frame 38 and a wheel 36 rotatably coupled to the wheel frame. The wheels 36 of the wheel assemblies 30 are configured to engage the surface of the soil, and the wheel assemblies 30 are configured to support at least a portion of the weight of the tillage implement 10. In the illustrated embodiment, each wheel frame 38 is pivotally coupled to the implement frame 14, thereby facilitating adjustment of the vertical position of the respective wheel(s) 36 relative to the implement frame 14. However, in other embodiments, at least one wheel frame 38 may be movably coupled to the implement frame 14 by another suitable connection (e.g. sliding connection, linkage assembly, etc.) that facilitates adjustment of the vertical position of the respective wheel(s) 36 relative to the implement frame 14. In a non-limiting embodiment, the height adjustment system 50 includes one or more actuators (e.g., hydraulic cylinder(s), etc.) that may be configured to adjust the vertical position of at least one wheel assembly 30 with respect to the frame 14. In some embodiments, the one or more actuators are configured to adjust the vertical position of all wheel assemblies 30 coupled to the implement frame 14 concurrently and by a substantially similar amount. In addition, in certain embodiments, at least one of the actuators of the height adjustment system 50 may be configured to adjust the vertical position of at least one respective wheel assembly 30 individually with respect to the frame 14 and other wheel assemblies.

In the illustrated embodiment, the tillage implement 10 includes disc blades 32 configured to engage a top layer of the soil. As the tillage implement 10 is towed through the field, the disc blades 32 are driven to rotate, thereby breaking up the top layer of the soil. In the illustrated embodiment, the disc blades 32 are arranged in two rows. However, in other embodiments, the disc blades may be arranged in more or fewer rows (e.g. 1, 3, 4, 5, 6, or more). Furthermore, in the illustrated embodiment, each row of disc blades 32 includes four gangs of disc blades 32. Two gangs of disc blades of the front row are coupled to the center section 18, two gangs of disc blades of the rear row are coupled to the center section 18, one gang of disc blades of the front row is coupled to the left wing section 20, one gang of disc blades of the rear row is coupled to the left wing section 20, one gang of disc blades of the front row is coupled to the right wing section 22, and one gang of disc blades of the rear row is coupled to the right wing section 22. While the tillage implement 10 includes eight gangs of disc blades 32 in the illustrated embodiment, in other embodiments, the tillage implement may include more or fewer gangs of disc blades (e.g. 2, 4, 6, 10, or more). Furthermore, the gangs of disc blades may be arranged in any suitable configuration on the implement frame.

The disc blades 32 of each gang are non-rotatably coupled to one another by a respective shaft, such that the disc blades 32 of each gang rotate together. Each shaft is rotatably coupled to a respective disc blade support 34, which is configured to support the gang, including the shaft and the disc blades 32. Furthermore, each disc blade support 34 is pivotally coupled to the frame 14 at a respective pivot point, thereby enabling the disc blade support 34 to rotate relative to the frame 14. Rotating the disc blade support 34 relative to the frame 14 controls the angle between the respective disc blades 32 and the direction of travel 28, thereby controlling the interaction of the disc blades 32 with the top layer of the soil. While each disc blade support 34 is pivotally coupled to the frame 14 in the illustrated embodiment, in other embodiments, at least one disc blade support (e.g., each disc blade support) may be fixed to the frame, such that the angle of the disc blades relative to the direction of travel is fixed.

In a non-limiting embodiment, at least a portion of the interaction of the disc blades 32 with the top layer of the soil is controlled by the vertical position of the aforementioned wheel assemblies 30. As used herein with regard to the wheel assemblies, “vertical position” refers to a vertical position/height of the wheel(s) of the wheel assembly relative to the respective section of the implement frame. Controlling the vertical position of the wheel assemblies 30 controls the height of the frame 14 above the ground, thereby controlling the penetration depth of the disc blades 32. In addition, because each wing section of the frame 14 is pivotally coupled to the center section 18 of the frame 14, controlling the vertical position of wheel assembly/assemblies 30 coupled to a wing section controls the penetration depth of the disc blades 32 coupled to the wing section independently of the disc blades 32 coupled to the center section 18. For example, if the wheel assembly/assemblies 30 coupled to the left wing section 20 are actuated to a lower vertical position, then the gang(s) of disc blades 32 coupled to the left wing section 20 may have a shallower interaction with the top layer of soil. Additionally, if the wheel assembly/assemblies 30 coupled to the left wing section 20 are actuated to a higher vertical position, then the gang(s) of disc blades 32 coupled to the left wing section 20 may have a deeper interaction with the top layer of soil.

Each disc blade support 34 may include any suitable structure(s) configured to support the respective gang (e.g. including a square tube, a round tube, a bar, a truss, other suitable structure(s), or a combination thereof). While the disc blades 32 supported by each disc blade support 34 are arranged in a respective gang (e.g. non-rotatably coupled to one another by a respective shaft) in the illustrated embodiment, in other embodiments, at least a portion of the disc blades supported by at least one disc blade support (e.g. all of the disc blades supported by the disc blade support) may be arranged in another suitable configuration (e.g., individually mounted and independently rotatable, mounted in groups and individually rotatable, etc.). For example, in certain embodiments, a first portion of the disc blades supported by a disc blade support may be arranged in a gang, and a second portion of the disc blades supported by the disc blade support may be individually mounted and independently rotatable.

While the tillage implement 10 includes the disc blades 32 in the illustrated embodiment, in other embodiments, the tillage implement may include other/additional ground engaging tool(s) (e.g., coupled to the disc blade support(s), coupled to the frame of the tillage implement, etc.). For example, in certain embodiments, the tillage implement may include tillage point assemblies (e.g., positioned behind the disc blades relative to the direction of travel) configured to engage the soil at a greater depth than the disc blades, thereby breaking up a lower layer of soil. Each tillage point assembly may include a tillage point and a shank. The shank may position the tillage point at a target depth beneath the soil surface, and the tillage point may break up the soil. The shape of each tillage point, the arrangement of the tillage point assemblies, and the number of tillage point assemblies may be selected to control tillage within the field. Furthermore, in certain embodiments, the tillage implement may include finishing discs (e.g. positioned behind the disc blades relative to the direction of travel). In such embodiments, as the tillage implement is towed through the field, the finishing discs may be driven to rotate, thereby sizing soil clods, leveling the soil surface, smoothing the soil surface, cutting residue on the soil surface, or a combination thereof. In addition, in certain embodiments, the tillage implement may include one or more other/additional suitable ground engaging tools, such as coulter(s), opener(s), tine(s), finishing reel(s), other suitable ground engaging tool(s), or a combination thereof. Furthermore, while the tillage implement is a vertical tillage implement in the illustrated embodiment, in other embodiments, the tillage implement may be a primary tillage implement or another suitable type of tillage implement.

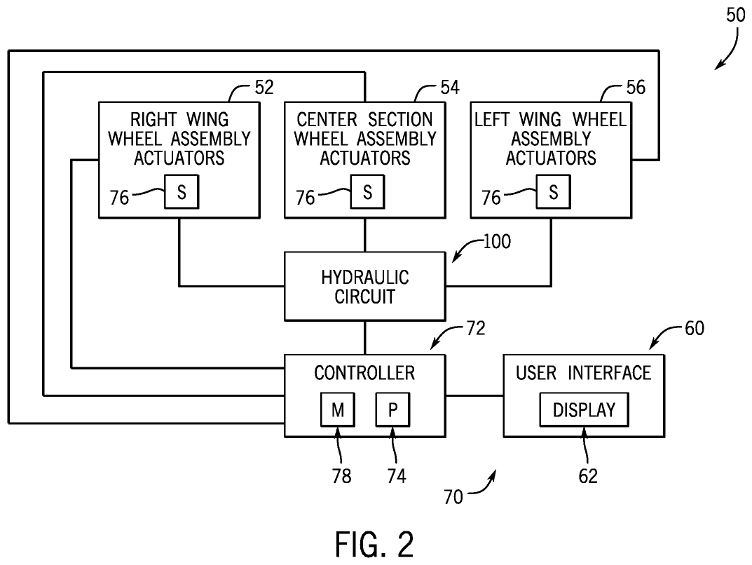

FIG. 2 is a schematic view of a height adjustment system 50 that may be employed within the agricultural implement 10 of FIG. 1. The height adjustment system 50 includes right wing wheel assembly actuator(s) 52, center section wheel assembly actuator(s) 54, left wing wheel assembly actuator(s) 56, a control system 70, a hydraulic circuit 100, and a user interface 60. The right wing wheel assembly actuator(s) 52 are configured to control the vertical position of the right wing wheel assembly/assemblies, the center section wheel assembly actuator(s) 54 are configured to control the vertical position of the center section wheel assembly/assemblies, and the left wing wheel assembly actuator(s) 56 are configured to control the vertical position of the left wing wheel assembly/assemblies. Additionally, the right wing wheel assembly actuator(s) 52, the center section wheel assembly actuator(s) 54, and the left wing wheel assembly actuator(s) 56 are fluidly coupled to components of the hydraulic circuit 100, as discussed in further detail below.

As discussed previously, an individual right wing wheel assembly includes a wheel frame and a suitable number of wheel(s) rotatably coupled to the wheel frame. In certain embodiments, one (1) right wing wheel assembly is coupled to the right wing section, with the right wing wheel assembly including one (1) wheel frame and two (2) wheels. However, in other embodiments, more than one right wing wheel assembly (2, 3, 4, etc.) may be coupled to the right wing section, and any suitable number of right wing wheel assemblies is considered within the scope of the various embodiments of the present disclosure. Additionally or alternatively, the right wing wheel assembly may include a single wheel or more than two (2) wheels, and these configurations are considered within the scope of the present disclosure. The right wing wheel assembly is configured to provide support for the right wing section and to enable the right wing section to travel through the field as the tillage implement is being towed in the direction of travel.

In a non-limiting embodiment, the wheel frame of the right wing wheel assembly is pivotally coupled to the right wing section of the frame, and the wheel frame is mechanically coupled to right wing wheel assembly actuator(s) 52. The right wing wheel assembly is configured to pivot between a first position and a second position based on extension of the right wing wheel assembly actuator(s) 52. In a non-limiting embodiment, the hydraulic circuit 100 may introduce specific volumes of hydraulic fluid to the rod end(s) or the cap end(s) of the right wing wheel assembly actuator(s) 52, thereby driving the right wing wheel assembly to rotate. As a result, the right wing wheel assembly may position the respective wheel(s) in a fully lowered position (e.g., corresponding to the first position of the right wing wheel assembly), a fully raised position (e.g., corresponding to the second position of the right wing wheel assembly), as well as intermediate positions between the fully lowered position and the fully raised position.

As it relates to the operation of the tillage implement, when the right wing wheel assembly is in the first position, the vertical position of the right wing section is at a maximum. When the vertical position of the right wing section is at a maximum, the corresponding disc blades coupled to the right wing section are disengaged from the top layer of the soil. On the other hand, when the right wing wheel assembly is in the second position, the vertical position of the right wing section is at a minimum. When the vertical position of the right wing section is at a minimum, the corresponding disc blades coupled to the right wing section are at a maximum penetration depth within the top layer of the soil. Additionally, when the right wing wheel assembly is in one of the intermediate positions, the vertical position of the right wing section is in an intermediate position. When the vertical position of the right wing section is in one of the intermediate positions, the corresponding disc blades coupled to the right wing section may be engaged with the top layer of soil at a penetration depth or disengaged with the top layer of soil.

Turning to the middle of the agricultural implement 10, an individual center section wheel assembly includes a wheel frame and a suitable number of wheel(s) rotatably coupled to the wheel frame. In certain embodiments, two (2) center section wheel assemblies are coupled to the center section, with the center section wheel assemblies each including one (1) wheel frame and two (2) wheels. However, in other embodiments, fewer or greater than two center section wheel assemblies (1, 3, 4, etc.), and any suitable number of center section wheel assemblies is considered within the scope of the various embodiments of the present disclosure. Additionally or alternatively, the center section wheel assemblies may include a single wheel or more than two (2) wheels, and these configurations are considered within the scope of the present disclosure. The center section wheel assemblies are configured to provide support for the center section and to enable the center section to travel through the field as the tillage implement is being towed in the direction of travel.

In a non-limiting embodiment, the wheel frame of the center section wheel assemblies are pivotally coupled to the center section of the frame, and the wheel frame is mechanically coupled to center section wheel assembly actuator(s) 54. The center section wheel assemblies are configured to pivot between a third position and a fourth position based on extension of each center section wheel assembly actuator(s) 54. In a non-limiting embodiment, the hydraulic circuit 100 may introduce specific volumes of hydraulic fluid to the rod end(s) or the cap end(s) of the center section wheel assembly actuator(s) 54, thereby driving the center section wheel assemblies to rotate. As a result, the center section wheel assemblies may position the respective wheel(s) in a fully lowered position (e.g., corresponding to the third position of the center section wheel assemblies), a fully raised position (e.g., corresponding to the fourth position of the center section wheel assemblies), as well as intermediate positions between the fully lowered position and the fully raised position.

As it relates to the operation of the tillage implement, when the center section wheel assemblies are in the third position, the vertical position of the center section is at a maximum. When the vertical position of the center section is at a maximum, the corresponding disc blades coupled to the center section are disengaged from the top layer of the soil. On the other hand, when the center section wheel assemblies are in the fourth position, the vertical position of the center section is at a minimum. When the vertical position of the center section is at a minimum, the corresponding disc blades coupled to the center section are at a maximum penetration depth within the top layer of the soil. Additionally, when the center section wheel assemblies are in one of the intermediate positions, the vertical position of the center section is in an intermediate position. When the vertical position of the center section is in one of the intermediate positions, the corresponding disc blades coupled to the center section may be engaged with the top layer of soil at a penetration depth or disengaged with the top layer of soil.

As discussed previously, an individual left wing wheel assembly includes a wheel frame and a suitable number of wheel(s) rotatably coupled to the wheel frame. In certain embodiments, one (1) left wing wheel assembly is coupled to the left wing section, with the left wing wheel assembly including one (1) wheel frame 38 and two (2) wheels 36. However, in other embodiments, more than one left wing wheel assembly (2, 3, 4, etc.), and any suitable number of left wing wheel assemblies is considered within the scope of the various embodiments of the present disclosure. Additionally or alternatively, the left wing wheel assembly may include a single wheel 36 or more than two (2) wheels, and these configurations are considered within the scope of the present disclosure. The left wing wheel assembly is configured to provide support for the left wing section and to enable the left wing section to travel through the field as the tillage implement is being towed in the direction of travel.

In a non-limiting embodiment, the wheel frame of the left wing wheel assembly is pivotally coupled to the left wing section of the frame, and the wheel frame is mechanically coupled to left wing wheel assembly actuator(s) 56. The left wing wheel assembly is configured to pivot between a fifth position and a sixth position based on extension of the left wing wheel assembly actuator(s) 56. In a non-limiting embodiment, the hydraulic circuit 100 may introduce specific volumes of hydraulic fluid to the rod end(s) or the cap end(s) of the left wing wheel assembly actuator(s) 56, thereby driving the left wing wheel assembly to rotate. As a result, the left wing wheel assembly may position the respective wheel(s) in a fully lowered position (e.g., corresponding to the fifth position of the left wing wheel assembly), a fully raised position (e.g., corresponding to the sixth position of the left wing wheel assembly), as well as intermediate positions between the fully lowered position and the fully raised position.

As it relates to the operation of the tillage implement, when the left wing wheel assembly is in the fifth position, the vertical position of the left wing section is at a maximum. When the vertical position of the left wing section is at a maximum, the corresponding disc blades coupled to the left wing section are disengaged from the top layer of the soil. On the other hand, when the left wing wheel assembly is in the sixth position, the vertical position of the left wing section is at a minimum. When the vertical position of the left wing section is at a minimum, the corresponding disc blades coupled to the left wing section are at a maximum penetration depth within the top layer of the soil. Additionally, when the left wing wheel assembly is in one of the intermediate positions, the vertical position of the left wing section is in an intermediate position. When the vertical position of the left wing section is in one of the intermediate positions, the corresponding disc blades coupled to the left wing section may be engaged with the top layer of soil at a penetration depth or disengaged with the top layer of soil.

The height adjustment system 50 also includes a control system 70 that is configured to receive input from the user interface 60 and control the hydraulic circuit 100 (e.g., based on the received input). The control system 70 includes a controller 72 that is communicatively coupled to the hydraulic circuit 100. In a non-limiting embodiment, the controller 72 is configured to receive feedback from sensors disposed on the wheel assemblies. In such an embodiment, the sensors are communicatively coupled to the controller 72. Further, the controller 72 may be configured to control the hydraulic circuit 100 based on the information received from the sensor feedback (e.g., from the sensors disposed on the wheel assemblies). Additionally or alternatively, the controller 72 may be configured to control the hydraulic circuit 100 based on the input received from the user interface 60.

In the illustrated embodiment, the controller 72 includes a memory 78 and a processor 74. The controller 72 may also include one or more storage devices and/or other suitable components. The processor 74 may be used to execute software, such as software for controlling the vertical position of the wheel assemblies in unison. In a non-limiting embodiment, the processor 74 may be used to execute software that enables the controller to control the vertical position of the right wing wheel assembly independently from the center section wheel assembly and the left wing wheel assembly. Additionally or alternatively, the processor 74 may be used to execute software that enables the controller to control the vertical position of the left wing wheel assembly independently from the center section wheel assembly and the right wing wheel assembly. Moreover, the processor 74 may include multiple microprocessors, one or more “general-purpose” microprocessors, one or more special-purpose microprocessors, and/or one or more application specific integrated circuits (ASICs), or some combination thereof. For example, the processor 74 may include one or more reduced instruction set (RISC) processors.

The memory 78 may include a volatile memory, such as random-access memory (RAM), and/or a nonvolatile memory, such as read-only memory (ROM). The memory 78 may store a variety of information and may be used for various purposes. For example, the memory 78 may store processor-executable instructions (e.g., firmware or software) for the processor 74 to execute, such as instructions for controlling the vertical position of the wheel assemblies in unison. In a non-limiting embodiment, the memory 78 may store processor-executable instructions related to controlling the vertical position of the right wing wheel assembly independently from the center section wheel assembly and left wing wheel assembly. Additionally or alternatively, the memory may store processor-executable instructions related to controlling the vertical position of the left wing wheel assembly independently from the center section wheel assembly and the right wing wheel assembly. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the vertical position of the wheel assemblies), and any other suitable data.

In some embodiments, the controller 72 may control the vertical position of the right wing wheel assembly, the center section wheel assemblies, and the left wing wheel assembly based on sensor feedback. For example, one or more sensors 76 may be positioned at one or more wheel assemblies. The sensor(s) 76 may include a pressure sensor, a position sensor, a height sensor, and the like. For example, a first pressure sensor may be fluidly coupled to the right wing wheel assembly actuator(s) 52, a second pressure sensor may be fluidly coupled to the center section wheel assembly actuator(s) 54, and a third pressure sensor may be fluidly coupled to the left wing wheel assembly actuator(s) 56. Each pressure sensor may monitor and output a signal indicative of a fluid pressure within the respective actuator(s). The controller 72 may control the hydraulic circuit 100 based on feedback from the pressure sensor(s) to control the vertical position of the corresponding wheel assembly/assemblies.

Position sensor(s) may be coupled to the respective wheel frame(s) of one or more wheel assemblies. For example, a first position sensor may be coupled to the wheel frame of the right wing wheel assembly, a second position sensor may be coupled to the wheel frame of a center section wheel assembly, and a third position sensor may be coupled to the wheel frame of the left wing wheel assembly. Each position sensor may monitor and output a signal corresponding to the vertical position of the respective wheel assembly. The controller 72 may control the hydraulic circuit 100 based on feedback from the position sensor(s) to control the vertical position of the corresponding wheel assembly/assemblies.

Additionally or alternatively, height sensor(s) may be coupled to one or more frame sections. Each height sensor may monitor and output a signal indicative of the height of the respective frame section above the ground, which is indicative of the penetration depth of the ground-engaging tools (e.g., disc blades, tillage point assemblies, finishing discs, coulter(s), opener(s), tine(s), finishing reel(s), other suitable ground engaging tool(s), etc.) coupled to the frame section. The controller 72 may control the hydraulic circuit 100 to adjust the vertical position of the corresponding wheel assembly/assemblies (e.g., the right wing wheel assembly, the center section wheel assemblies, the left wing wheel assembly, etc.) based on feedback from the height sensor(s) to adjust the penetration depth of the respective ground-engaging tools.

In the illustrated embodiment, the user interface 60 is communicatively coupled to the controller 72. The user interface 60 is configured to receive input from an operator and to provide information to the operator (e.g., hydraulic fluid pressure(s) and/or flow rate(s), wheel assembly vertical position(s), etc.). The user interface 60 may include any suitable input device(s) for receiving input, such as a keyboard, a mouse, button(s), switch(es), knob(s), other suitable input device(s), or a combination thereof. In addition, the user interface 60 may include any suitable output device(s) for presenting information to the operator, such as speaker(s), indicator light(s), other suitable output device(s), or a combination thereof. In the illustrated embodiment, the user interface 60 includes a display 62 configured to present visual information to the operator (e.g., real time/near real time information, such as hydraulic fluid pressure(s) and/or flow rate(s), wheel assembly vertical position(s), etc.). In a non-limiting embodiment, the display 62 may include a touchscreen interface configured to receive input from the operator (e.g., a capacitive touch screen with haptic feedback).

In certain embodiments, the user interface 60 is configured to receive input from the operator indicative of a command to adjust the vertical position of the right wing wheel assembly, the center section wheel assemblies, and the right wing wheel assembly in unison. In certain embodiments, the user interface 60 is configured to enable the operator to input a command to adjust the vertical position of the right wing wheel assembly independently from the other wheel assemblies. Additionally or alternatively, in certain embodiments, the user interface 60 is configured to enable the operator to input a command to adjust the vertical position of the left wing wheel assembly independently from the other wheel assemblies. Furthermore, in certain embodiments, the user interface 60 may enable the operator to input a target vertical position corresponding to a desired setpoint for the vertical position of the wheel assemblies, an adjustment distance to the vertical position for each wing wheel assembly, other suitable parameter(s) (e.g., target height of each section above the ground, etc.), or a combination thereof. The controller 72 is configured to receive the inputs from the user interface 60 and to control the vertical position(s) of the wheel assembly/assemblies based on the inputs received from the operator via the user interface 60.

In certain embodiments, the controller 72 is configured to output information to the user interface 60 corresponding to the sensor feedback received from the sensor(s) 76. For example, in response to receiving signal(s) from one or more of the pressure sensors indicative of the fluid pressure being above or below a threshold fluid pressure, the controller 72 may instruct the user interface 60 to present a corresponding indication to the operator. Additionally or alternatively, in response to receiving signal(s) from one or more of the position sensors indicative of the position of the respective wheel frame(s) being above or below a threshold minimum or maximum position, the controller 72 may instruct the user interface 60 to present a corresponding indication to the operator. Furthermore, in response to receiving signal(s) from one or more of the height sensors indicative of the penetration depth of one or more of the ground-engaging tools being above or below a penetration depth threshold, the controller 72 may instruct the user interface 60 to present a corresponding indication to the operator. The user interface 60 is configured to provide the operator with the information from the controller 72 (e.g., via the display 62). For example, in response to an indication on the user interface 60, the operator may input, via the user interface 60, an input to adjust the vertical position of one or more wheel assemblies.

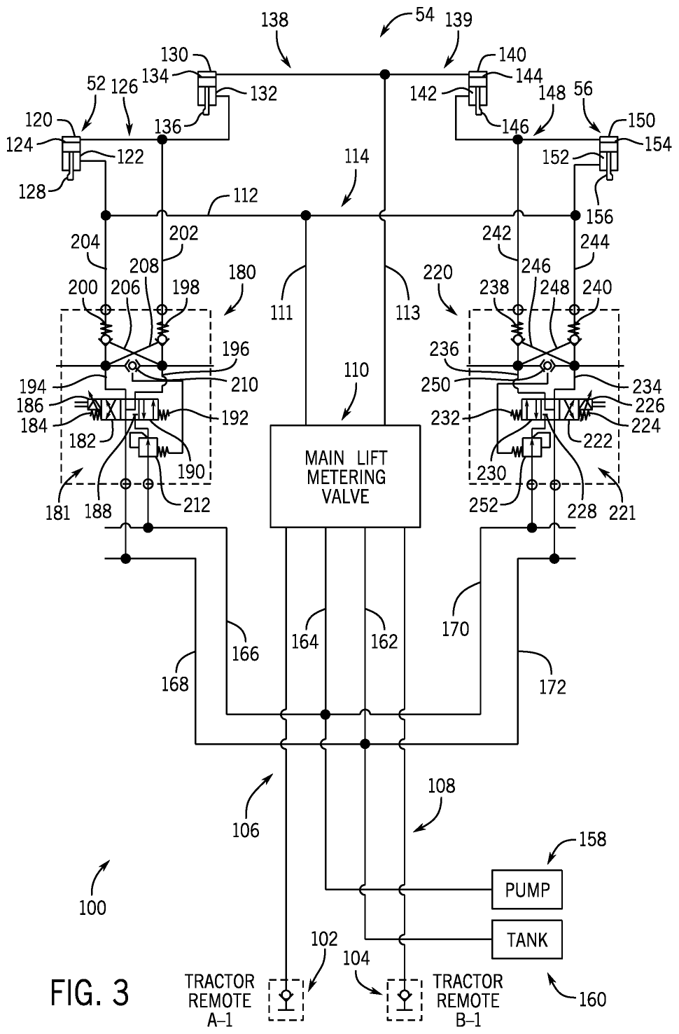

FIG. 3 is a schematic diagram of an embodiment of a hydraulic circuit 100 that may be employed within the height adjustment system of FIG. 2. In the illustrated embodiment, the hydraulic circuit 100 is configured to control the vertical positions of the wheel assemblies with respect to the frame of the tillage implement. The hydraulic circuit 100 includes a first hydraulic fluid input 102, a second hydraulic fluid input 104, a main lift metering valve 110, a right wing control valve circuit 180, and a left wing control valve circuit 220. Furthermore, the right wing wheel assembly actuator(s) 52 include a single right wing lift cylinder 120, the center section wheel assembly actuator(s) 54 include a right main lift cylinder 130 and a left main lift cylinder 140, and the left wing wheel assembly actuator(s) 56 include a single left wing lift cylinder 150. The first hydraulic fluid input 102 is configured to provide hydraulic fluid through a first supply conduit 106 to the main lift metering valve 110. In addition, the second hydraulic fluid input 104 is configured to provide hydraulic fluid through a second supply conduit 108 to the main lift metering valve 110. During operation, the main lift metering valve 110 is configured to receive hydraulic fluid from one of the first hydraulic fluid input 102 or the second hydraulic fluid input 104, and hydraulic fluid may drain through the other hydraulic fluid input. For example, a tractor remote within the work vehicle, which is fluidly coupled to the hydraulic fluid inputs, may be controlled to selectively supply hydraulic fluid to the first hydraulic fluid input 102 or to the second hydraulic fluid input 104, while enabling hydraulic fluid to drain through the other hydraulic fluid input.

The main lift metering valve 110 may receive hydraulic fluid from the first supply conduit 106 and output hydraulic fluid through the retraction conduit 111. The retraction conduit 111 is fluidly connected to a right retraction branch 112 and fluidly connected to a left retraction branch 114, such that hydraulic fluid output from the main lift metering valve 110 through the retraction conduit 111 is split between the right branch 112 and the left branch 114. In addition, the right branch retraction conduit 112 is configured to provide hydraulic fluid to a rod end 122 of the right wing lift cylinder 120, and the left branch retraction conduit 114 is configured to provide hydraulic fluid to a rod end 152 of the left wing lift cylinder 150.

In addition, the main lift metering valve 110 may receive hydraulic fluid from the second supply conduit 108 and output hydraulic fluid through the extension conduit 113. The extension conduit 113 is fluidly connected to a right branch extension conduit 138 and fluidly connected to a left branch extension conduit 139, such that hydraulic fluid output from the main lift metering valve 110 through the extension conduit 113 is split between the right branch 138 and the left branch 139. In addition, the right branch extension conduit 138 is configured to provide hydraulic fluid to a cap end 134 of the right main lift cylinder 130, and the left branch extension conduit 139 is configured to provide hydraulic fluid to a cap end 144 of the left main lift cylinder 140.

In the illustrated embodiment, the right wing lift cylinder 120 includes a rod end 122, a cap end 124, and an actuating piston rod 128. The rod end 122 of the right wing lift cylinder 120 is fluidly coupled to the right branch retraction conduit 112 and is configured to receive hydraulic fluid from the right branch retraction conduit 112. When the right wing lift cylinder 120 receives hydraulic fluid into the rod end 122, the hydraulic fluid drives the piston rod 128 to retract. In addition, the cap end 124 of the right wing lift cylinder 120 is fluidly coupled to a first cylinder conduit 126 that connects the cap end 124 of the right wing lift cylinder 120 to a rod end 132 of the right main lift cylinder 130. In the illustrated embodiment, when the hydraulic fluid in the rod end 122 of the right wing lift cylinder 120 drives the piston rod 128 to retract, the piston rod 128 drives the hydraulic fluid present in the cap end 124 of the right wing lift cylinder 120 out of the cap end 124 and into the first cylinder conduit 126. As discussed in more detail below, when hydraulic fluid is received into the cap end 124 via the first cylinder conduit 126, the piston rod 128 is driven to extend, thereby driving hydraulic fluid present in the rod end 122 of the right wing lift cylinder 120 into the right branch retraction conduit 112.

As discussed previously, the first cylinder conduit 126 fluidly connects the cap end 124 of the right wing lift cylinder 120 and the rod end 132 of the right main lift cylinder 130. In a non-limiting embodiment, the right main lift cylinder 130 includes the rod end 132, a cap end 134, and an actuating piston rod 136. The rod end 132 of the right main lift cylinder 130 is fluidly coupled to the first cylinder conduit 126 and is configured to receive hydraulic fluid from the first cylinder conduit 126. When the right main lift cylinder 130 receives hydraulic fluid into the rod end 132, the hydraulic fluid drives the piston rod 136 to retract. In addition, the cap end 134 of the right main lift cylinder 130 is fluidly coupled to the right branch extension conduit 138 that connects the cap end 134 of the right main lift cylinder 130 to the extension conduit 113. In the illustrated embodiment, when the hydraulic fluid in the rod end 132 of the right main lift cylinder 130 drives the piston rod 136 to retract, the piston rod 136 drives the hydraulic fluid present in the cap end 134 of the right main lift cylinder 130 out of the cap end 134 and into the right branch extension conduit 138, then to the extension conduit 113, and then to the main lift metering valve 110. As discussed in more detail below, when hydraulic fluid is received into the cap end 134 via the right branch extension conduit 138, the piston rod 136 is driven to extend, thereby driving hydraulic fluid present in the rod end 132 of the right main lift cylinder 130 into the first cylinder conduit 126.

In the illustrated embodiment, the left wing lift cylinder 150 includes a rod end 152, a cap end 154, and an actuating piston rod 156. The rod end 152 of the left wing lift cylinder 150 is fluidly coupled to the left branch retraction conduit 114 and is configured to receive hydraulic fluid from the left branch retraction conduit 114. When the left wing lift cylinder 150 receives hydraulic fluid into the rod end 152, the hydraulic fluid drives the piston rod 156 to retract. In addition, the cap end 154 of the left wing lift cylinder 150 is fluidly coupled to a second cylinder conduit 148 that connects the cap end 154 of the left wing lift cylinder 150 to the rod end 142 of the left main lift cylinder 140. In the illustrated embodiment, when the hydraulic fluid in the rod end 152 of the left wing lift cylinder 150 drives the piston rod 156 to retract, the piston rod 156 drives the hydraulic fluid present in the cap end 154 of the left wing lift cylinder 150 out of the cap end 154 and into the second cylinder conduit 148. As discussed in more detail below, when hydraulic fluid is received into the cap end 154 via the second cylinder conduit 148, the piston rod 156 is driven to extend, thereby driving hydraulic fluid present in the rod end 152 of the left wing lift cylinder 150 into the left branch retraction conduit 114.

As discussed previously, the second cylinder conduit 148 fluidly connects the cap end 154 of the left wing lift cylinder 150 and the rod end 142 of the left main lift cylinder 140. In a non-limiting embodiment, the left main lift cylinder 140 includes the rod end 142, a cap end 144, and an actuating piston rod 146. The rod end 142 of the left main lift cylinder 140 is fluidly coupled to the second cylinder conduit 148 and is configured to receive hydraulic fluid from the second cylinder conduit 148. When the left main lift cylinder 140 receives hydraulic fluid into the rod end 142, the hydraulic fluid drives the piston rod 146 to retract. In addition, the cap end 144 of the left main lift cylinder 140 is fluidly coupled to the left branch extension conduit 139 that connects the cap end 144 of the left main lift cylinder 140 to the extension conduit 113. In the illustrated embodiment, when the hydraulic fluid in the rod end 142 of the left main lift cylinder 140 drives the piston rod 146 to retract, the piston rod 146 drives the hydraulic fluid present in the cap end 144 of the left main lift cylinder 140 out of the cap end 144 and into the left branch extension conduit 139, then to the extension conduit 113, and then to the main lift metering valve 110. As discussed in more detail below, when hydraulic fluid is received into the cap end 144 via the left branch extension conduit 139, the piston rod 146 is driven to extend, thereby driving hydraulic fluid present in the rod end 142 of the left main lift cylinder 140 into the second cylinder conduit 148.

In a non-limiting embodiment, the frame of the right wing wheel assembly is coupled to the right wing lift cylinder 120, the frame of a first center section wheel assembly is coupled to the right main lift cylinder 130, the frame of a second center section wheel assembly is coupled to the left main lift cylinder 140, and the frame of the left wing wheel assembly is coupled to the left wing lift cylinder 150. By providing hydraulic fluid to the first hydraulic fluid input 102, hydraulic fluid flows through the first supply conduit 106 to the main lift metering valve 110. The main lift metering valve 110 outputs the hydraulic fluid through the retraction conduit 111, thereby causing hydraulic fluid to flow into the rod ends 122, 132, 142, 152 of the respective cylinders. As a result, the respective piston rods 128, 136, 146, 156 retract, and hydraulic fluid from the cap ends 124, 134, 144, 154 is received by the extension conduit 113. Moreover, retraction of the piston rods of the respective cylinders drives the wheel assemblies to move to a lower vertical position.

Furthermore, by providing hydraulic fluid to the second hydraulic fluid input 104, the hydraulic fluid flows through the second supply conduit 108 to the main lift metering valve 110. The main lift metering valve 110 outputs the hydraulic fluid through the extension conduit 113, thereby causing hydraulic fluid to flow into the cap ends 124, 134, 144, 154 of the respective cylinders. As a result, the respective piston rods 128, 136, 146, 156 extend, and hydraulic fluid from the rod ends 122, 132, 142, 152 is received by the retraction conduit 111. Moreover, retraction of the piston rods of the respective cylinders drives the wheel assemblies to move to a higher vertical position. In certain embodiments, providing hydraulic fluid to the first hydraulic fluid input 102 may cause the main lift metering valve 110 to output hydraulic fluid through the extension conduit 113, and providing hydraulic fluid to the second hydraulic fluid input 104 may cause the main lift metering valve 110 to output hydraulic fluid through the retraction conduit 111.

Additionally, a hydraulic pump 158 is located on the work vehicle (e.g., tractor) that tows the tillage implement. The hydraulic pump 158 is configured to receive hydraulic fluid from a tank 160 and to provide the fluid to the main lift metering valve 110 via a supply line 164. Further, the tank 160 is configured to receive hydraulic fluid from the main lift metering valve 110 via a return line 162 that fluidly connects the tank 160 to the main lift metering valve 110.

In certain embodiments, the controller controls the main lift metering valve 110 to fluidly connect the supply line 164 to the retraction conduit 111, and to fluidly connect the return line 162 to the extension conduit 113. In this embodiment, the controller controls the pump 158 to introduce hydraulic fluid to the retraction conduit 111, via the main lift metering valve 110, via the supply line 164. As a result, the controller may control the vertical positions of the wheel assemblies substantially in unison, driving the piston rods 128, 136, 146, 156 to retract. Further, hydraulic fluid returns to the main lift metering valve via the extension conduit 113, and then returns to the tank 160 via the return line 162. In other embodiments, the controller may control the main lift metering valve 110 to fluidly connect the supply line 164 to the extension conduit 113, and to fluidly connect the return line 162 to the retraction conduit 111. In this embodiment, the controller controls the pump 158 to introduce hydraulic fluid to the extension conduit 113, via the main lift metering valve 110, via the supply line 164. As a result, the controller may control the vertical positions of the wheel assemblies substantially in unison, driving the piston rods 128, 136, 146, 156 to extend. Further, hydraulic fluid returns to the main lift metering valve 110 via the retraction conduit 111, and then returns to the tank 160 via the return line 162.

In the illustrated embodiment, the hydraulic circuit 100 includes a right wing control valve circuit 180 configured to control the right wing lift cylinder 120 independently of the other cylinders, and the hydraulic circuit 100 includes a left wing control valve circuit 220 configured to control the left wing lift cylinder 150 independently of the other cylinders. The right wing control valve circuit 180 receives hydraulic fluid from the hydraulic pump 158 via a right wing circuit pump conduit 166. The right wing circuit pump conduit 166 fluidly couples the hydraulic pump 158 and the right wing control valve circuit 180. Additionally, a right wing circuit tank conduit 168 fluidly couples the tank 160 and the right wing control valve circuit 180. In addition, the left wing control valve circuit 220 receives hydraulic fluid from the hydraulic pump 158 via a left wing circuit pump conduit 170. The left wing circuit pump conduit 170 fluidly couples the hydraulic pump 158 and the left wing control valve circuit 220. Additionally, a left wing circuit tank conduit 172 fluidly couples the tank 160 and the left wing control valve circuit 220.

In the illustrated embodiment, the right wing control valve circuit 180 includes a first control valve 181 configured to facilitate the flow of hydraulic fluid into appropriate fluid conduits for adjusting the vertical position of the right wing wheel assembly. In the illustrated embodiment, the control valve 181 is a four-way, three-position solenoid activated valve. In the illustrated embodiment, the control valve 181 includes a first position 182, a second position 188, and a third position 190. With the control valve 181 in the first position 182, hydraulic fluid from the hydraulic pump 158 is directed along a first valve output conduit 194, through a first check valve 200, and through a second valve output conduit 204. Additionally, with the control valve 181 in the first position 182, a third valve output conduit 196 is fluidly connected to the right wing circuit tank conduit 168, enabling flow from the third valve output conduit 196 to return to the tank. The first check valve 200 is configured to enable flow in one direction and normally block flow in the other direction. In the illustrated embodiment, the first check valve 200 is configured to enable flow from the first valve output conduit 194 to the second valve output conduit 204, and normally block flow of fluid from the second valve output conduit 204 to the first valve output conduit 194. As discussed in more detail below, the first check valve 200 is configured to open and enable flow from the second valve output conduit 204 to the first valve output conduit 194 when a first pilot conduit 206 is pressurized, thereby opening the first check valve 200. The right wing control valve circuit 180 includes a second check valve 198 configured to enable flow in one direction and normally block flow in the other direction. In the illustrated embodiment, the second check valve 198 is configured to enable flow from the third valve output conduit 196 to a fourth valve output conduit 202, and normally block flow of fluid from the fourth valve output conduit 202 to the third valve output conduit 196. As discussed in more detail below, the second check valve 198 is configured to open and enable hydraulic fluid to flow from the fourth valve output conduit 202 to the third valve output conduit 196 when a second pilot conduit 208 is pressurized, thereby opening the second check valve 198.

The second valve output conduit 204 is fluidly coupled to the rod end 122 of the right wing lift cylinder 120. By introducing hydraulic fluid to the rod end 122 of the right wing lift cylinder 120, as discussed previously, the piston rod 128 is driven to retract, thereby decreasing the vertical position of the corresponding right wing wheel assembly. As the cylinder retracts, hydraulic fluid is driven from the cap end 124 into the fourth valve output conduit 202. The hydraulic fluid is driven into the fourth valve output conduit 202, rather than the rod end 132 of right main lift cylinder 130, because the right main lift cylinder 130 is blocked from receiving hydraulic fluid as the main lift metering valve 110 is not driving this fluid motion. Because the control valve 181 is in the first position 182, the second pilot conduit 208 is pressurized, thereby enabling the hydraulic fluid to pass through the second check valve 198, through the third valve output conduit 196, and return back to the tank 160 through the right wing circuit tank conduit 168.

When the control valve 181 is in the second position 188, the control valve 181 blocks hydraulic fluid from flowing from the hydraulic pump 158 into any of the above mentioned valve output conduits 194, 204, 196, 202. In addition, when the control valve 181 is in the second position 188, a fluid connection between the second valve output conduit 204 and the right wing circuit tank conduit 168 and a fluid connection between the fourth valve output conduit 202 and the right wing circuit tank conduit 168 are established. Accordingly, the first pilot conduit 206 and the second pilot conduit 208 are not pressurized. As a result, fluid flow from the cap end 124 and the rod end 122 of the right wing lift cylinder 120 is blocked, thereby blocking movement of the piston rod 128 (e.g., while hydraulic fluid is not provided by the main lift metering valve 110). In the illustrated embodiment, the control valve 181 includes a first biasing spring 184 and a second biasing spring 192. The first biasing spring 184 and the second biasing spring 192 bias the control valve 181 to normally be in the second position 188. The control valve 181 includes a solenoid 186 that is configured to provide a force that overcomes the force of the first biasing spring 184 and the second biasing spring 192, thereby driving the control valve to the first position 182 or to the third position 190.

The solenoid 186 is communicatively coupled to the controller, thereby enabling the controller to control the control valve 181. Accordingly, the controller may control the right wing lift cylinder 120. For example, the controller may control the solenoid 186 to drive the control valve 181 to the third position 190. With the control valve 181 in the third position 190, a fluid connection is established between the third valve output conduit 196 and the right wing circuit pump conduit 166, and a fluid connection is established between the first valve output conduit 194 and the right wing circuit tank conduit 168. Accordingly, hydraulic fluid from the hydraulic pump 158 flows through the third valve output conduit 196, through the second check valve 198, and through the fourth valve output conduit 202. The fourth valve output conduit 202 is fluidly coupled to the cap end 124 of the right wing lift cylinder 120. By introducing hydraulic fluid to the cap end 124 of the right wing lift cylinder 120, as discussed previously, the piston rod 128 is driven to extend, thereby increasing the vertical position of the right wing wheel assembly. As the cylinder extends, hydraulic fluid is driven from the rod end 122 into the second valve output conduit 204. The hydraulic fluid is driven into the second valve output conduit 204, rather than the right branch retraction conduit 112, because the right branch retraction conduit 112 is blocked from receiving hydraulic fluid as the main lift metering valve 110 is not driving this fluid motion. Because the control valve 181 is in the third position 190, the first pilot conduit 206 is pressurized, thereby opening the first check valve 200. As a result, hydraulic fluid flows through the first check valve 200, through the first valve output conduit 194, and returns to the tank 160 through the right wing circuit tank conduit 168.

In the illustrated embodiment, the right wing control valve circuit 180 includes a shuttle valve 210 configured to transfer a pressure from the rod end 122 or the cap end 124 of the right wing lift cylinder 120 to a spring end of a compensator 212 disposed along the right wing circuit pump conduit 166. The shuttle valve 210 and the compensator 212 may be configured to create a substantially constant pressure differential across the control valve 181, thereby facilitating a fluid flow more linearly related to the opening of the control valve 181 in the various positions. As a result, the consistency of the flow through the control valve 181 relative to the position of the control valve 181 may be enhanced, thereby facilitating controller control of the control valve 181. In certain embodiments, the shuttle valve and the compensator may be omitted. Furthermore, in certain embodiments, the check valves and the pilot conduits may be omitted. In such embodiments, the control valve may be configured to block flow through the control valve while in the second position. In certain embodiments, the right wing control valve circuit 180 enables the operator to adjust the vertical position of the right wing wheel assembly while the tillage implement is being towed and is in operation.

In the illustrated embodiment, the left wing control valve circuit 220 includes a control valve 221 configured to facilitate the flow of hydraulic fluid into appropriate fluid conduits for adjusting the vertical position of the left wing wheel assembly. In the illustrated embodiment, the control valve 221 is a four-way, three-position solenoid activated valve. In the illustrated embodiment, the control valve 221 includes a first position 222, a second position 228, and a third position 230. With the control valve 221 in the first position 222, hydraulic fluid from the hydraulic pump 158 is directed along a fifth valve output conduit 234, through a third check valve 240, and through a sixth valve output conduit 244. Additionally, with the control valve 221 in the first position 222, a seventh valve output conduit 236 is fluidly connected to the left wing circuit tank conduit 172, enabling flow from the seventh valve output conduit 236 to return to the tank. The third check valve 240 is configured to enable flow in one direction and normally block flow in the other direction. In the illustrated embodiment, the third check valve 240 is configured to enable flow from the fifth valve output conduit 234 to the sixth valve output conduit 244, and normally block flow of fluid from the sixth valve output conduit 244 to the fifth valve output conduit 234. As discussed in more detail below, the third check valve 240 is configured to open and enable flow from the sixth valve output conduit 244 to the fifth valve output conduit 234 when a third pilot conduit 248 is pressurized, thereby opening the third check valve 240. The left wing control valve circuit 220 includes a fourth check valve 238 configured to enable flow in one direction and normally block flow in the other direction. In the illustrated embodiment, the fourth check valve 238 is configured to enable flow from the seventh valve output conduit 236 to an eighth valve output conduit 242, and normally block flow of fluid from the eighth valve output conduit 242 to the seventh valve output conduit 236. As discussed in more detail below, the fourth check valve 238 is configured to open and enable fluid to flow from the eighth valve output conduit 242 to the seventh valve output conduit 236 when a fourth pilot conduit 246 is pressurized, thereby opening the fourth check valve 238.

The sixth valve output conduit 244 is fluidly coupled to the rod end 152 of the left wing lift cylinder 150. By introducing hydraulic fluid to the rod end 152 of the left wing lift cylinder 150, as discussed previously, the piston rod 156 is driven to retract, thereby decreasing the vertical position of the corresponding left wing wheel assembly. As the cylinder retracts, hydraulic fluid is driven from the cap end 154 and into the eighth valve output conduit 242. The hydraulic fluid is driven into the eighth valve output conduit 242, rather than the rod end 142 of left main lift cylinder 140, because the left main lift cylinder 140 is blocked from receiving hydraulic fluid as the main lift metering valve 110 is not driving this fluid motion. Because the control valve 221 is in the first position 222, the fourth pilot conduit 246 is pressurized, thereby enabling the hydraulic fluid to pass through the fourth check valve 238, through the seventh valve output conduit 236, and return back to the tank 160 through the left wing circuit tank conduit 172.

When the control valve 221 is in the second position 228, the control valve 221 blocks hydraulic fluid from flowing from the hydraulic pump 158 into any of the above mentioned valve output conduits 234, 244, 236, 242. In addition, when the control valve 221 is in the second position 228, a fluid connection between the sixth valve output conduit 244 and the left wing circuit tank conduit 172 and a fluid connection between the eighth valve output conduit 242 and the left wing circuit tank conduit 172 is established. Accordingly, the third pilot conduit 248 and the fourth pilot conduit 246 are not pressurized. As a result, fluid flow from the cap end 154 and the rod end 152 of the left wing lift cylinder 150 is blocked, thereby blocking movement of the piston rod 156 (e.g., while hydraulic fluid is not provided by the main lift metering valve 110). In the illustrated embodiment, the control valve 221 includes a third biasing spring 224 and a fourth biasing spring 232. The third biasing spring 224 and the fourth biasing spring 232 bias the control valve 221 to normally be in the second position 228. The control valve 221 includes a solenoid 226 that is configured to provide a force that overcomes the force of the third biasing spring 224 and the fourth biasing spring 232, thereby driving the control valve 221 to the first position 222, or to the third position 230.

The solenoid 226 is communicatively coupled to the controller, thereby enabling the controller to control the control valve 221. Accordingly, the controller may control the left wing lift cylinder 150. For example, the controller may control the solenoid 226 to drive the control valve 221 to the third position 230. With the control valve 221 in the third position 230, a fluid connection is established between the seventh valve output conduit 236 and the left wing circuit pump conduit 170, and a fluid connection is established between the fifth valve output conduit 234 and the left wing circuit tank conduit 172. Accordingly, hydraulic fluid from the hydraulic pump 158 flows through the seventh valve output conduit 236, through the fourth check valve 238, and through the eighth valve output conduit 242. The eighth valve output conduit 242 is fluidly coupled to the cap end 154 of the left wing lift cylinder 150. By introducing hydraulic fluid to the cap end 154 of the left wing lift cylinder 150, as discussed previously, the piston rod 156 is driven to extend, thereby increasing the vertical position of the left wing wheel assembly. As the cylinder extends, hydraulic fluid is driven from the rod end 152 and into the sixth valve output conduit 244. The hydraulic fluid is driven into the sixth valve output conduit 244, rather than the left branch retraction conduit 114, because the left branch retraction conduit 114 is blocked from receiving hydraulic fluid as the main lift metering valve 110 is not driving this fluid motion. Because the control valve 221 is in the third position 230, the third pilot conduit 248 is pressurized, thereby opening the third check valve 240. As a result, hydraulic fluid flows through the third check valve 240, through the fifth valve output conduit 234, and returns to the tank 160 through the left wing circuit tank conduit 172.

In the illustrated embodiment, the left wing control valve circuit 220 includes a shuttle valve 250 configured to transfer a pressure from the rod end 152 or the cap end 154 of the left wing lift cylinder 150 to a spring end of a compensator 252 disposed along the left wing circuit pump conduit 170. The shuttle valve 250 and the compensator 252 may be configured to create a substantially constant pressure differential across the control valve 221, thereby facilitating a fluid flow more linearly related to the opening of the control valve 221 in the various positions. As a result, the consistency of the flow through the control valve 221 relative to the position of the control valve 221 may be enhanced, thereby facilitating controller control of the control valve 221. In certain embodiments, the shuttle valve and the compensator may be omitted. Furthermore, in certain embodiments, the check valves and the pilot conduits may be omitted. In such embodiments, the control valve may be configured to block flow through the control valve while in the second position. In certain embodiments, the left wing control valve circuit 220 enables the operator to adjust the vertical position of the left wing wheel assembly while the tillage implement is being towed and is in operation. In certain embodiments, the right wing lift cylinder 120 and the left wing lift cylinder 150 may be manually actuated, rather than being controlled by the controller. In other embodiments, extension of the piston rods 128, 136, 146, 156 may drive the wheel assemblies upwards towards the frame, while retraction of the piston rods 128, 136, 146, 156 may drive the wheel assemblies downwards away from the frame.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A height adjustment system for an agricultural implement, comprising:
a main lift cylinder configured to control a vertical position of a center section wheel assembly, wherein the center section wheel assembly is movably coupled to a center section of a frame of the agricultural implement;
a wing lift cylinder configured to control a vertical position of a wing section wheel assembly, wherein the wing section wheel assembly is movably coupled to a wing section of the frame of the agricultural implement; and
a hydraulic circuit comprising:
a main lift metering valve configured to control hydraulic fluid flow to and from the main lift cylinder and the wing lift cylinder to control the vertical position of the center section wheel assembly and the vertical position of the wing section wheel assembly in unison; and
a wing control valve circuit comprising a first control valve, wherein the first control valve is configured to control fluid flow to and from the wing lift cylinder to control the vertical position of the wing section wheel assembly independently of the center section wheel assembly.

2. The height adjustment system of claim 1, comprising:
an additional wing lift cylinder configured to control an additional vertical position of an additional wing section wheel assembly, wherein the additional wing section wheel assembly is movably coupled to an additional wing section of the frame of the agricultural implement; and
wherein the hydraulic circuit comprises an additional wing control valve circuit comprising a second control valve is configured to control fluid flow to and from the additional wing lift cylinder to control the additional vertical position of the additional wing section wheel assembly independently of the center section wheel assembly.

3. The height adjustment system of claim 1, wherein the first control valve is a four-way, three-position, solenoid activated valve.

4. The height adjustment system of claim 2, wherein the second control valve is a four-way, three-position, solenoid activated valve.

5. The height adjustment system of claim 1, comprising:
a control system comprising a controller having a processor and a memory, wherein the controller is configured to:
receive from a user interface a first input corresponding to a first adjustment in the vertical position of the wing section wheel assembly; and
control the first control valve based on the first input received from the user interface.

6. The height adjustment system of claim 1, wherein the wing control valve circuit comprises:
a compensator with a spring end, wherein the compensator is disposed along an input conduit to the wing control valve circuit; and
a shuttle valve configured to transfer a pressure from a rod end or a cap end of the wing lift cylinder to the spring end of the compensator, wherein the shuttle valve and the compensator are configured to create a substantially constant pressure differential across the first control valve.

7. The height adjustment system of claim 1, wherein the wing control valve circuit comprises:
a check valve configured to enable fluid flow from a first output valve conduit to a second output valve conduit, and normally block fluid flow from the second output valve conduit to the first output valve conduit; and
a pilot conduit fluidly coupled to the check valve, wherein the check valve is configured to open and enable fluid to flow from the second output valve conduit to the first output valve conduit in response to the pilot conduit being pressurized.

8. The height adjustment system of claim 1, wherein the hydraulic circuit comprises:
a first hydraulic fluid input configured to provide hydraulic fluid through a first supply conduit to the main lift metering valve; and
a second hydraulic fluid input configured to provide hydraulic fluid through a second conduit to the main lift metering valve.

9. An agricultural implement, comprising:
a frame comprising a center section, a left wing section, and a right wing section;
a center section wheel assembly movably coupled to the center section;
a right wing wheel assembly movably coupled to the right wing section;
a left wing wheel assembly movably coupled to the left wing section;
a height adjustment system comprising:
a main lift cylinder configured to control a first vertical position of the center section wheel assembly;
a right wing lift cylinder configured to control a second vertical position of the right wing wheel assembly;
a left wing lift cylinder configured to control a third vertical position of the left wing wheel assembly; and
a hydraulic circuit comprising:
a main lift metering valve configured to control hydraulic fluid flow to and from the main lift cylinder, the right wing lift cylinder, and the left wing lift cylinder to control the first vertical position of the center section wheel assembly, the second vertical position of the right wing wheel assembly, and the third vertical position of the left wing wheel assembly in unison;
a right wing control valve circuit comprising a first control valve, wherein the first control valve is configured to control fluid flow to and from the right wing lift cylinder to control the second vertical position of the right wing wheel assembly independently of the center section wheel assembly; and
a left wing control valve circuit comprising a second control valve, wherein the second control valve is configured to control fluid flow to and from the left wing lift cylinder to control the third vertical position of the left wing wheel assembly independently of the center section wheel assembly.

10. The agricultural implement of claim 9, comprising:
a control system comprising a controller having a processor and a memory, wherein the controller is configured to:
receive from a user interface a first input corresponding to a first adjustment in the second vertical position of the right wing wheel assembly; and
control the first control valve based on the first input received from the user interface.

11. The agricultural implement of claim 10, wherein the controller is configured to:
receive from the user interface a second input corresponding to a second adjustment in the third vertical position of the left wing wheel assembly; and
control the second control valve based on the second input received from the user interface.

12. The agricultural implement of claim 11, comprising:
a first position sensor configured to monitor the first vertical position of the center section wheel assembly;
a second position sensor configured to monitor the second vertical position of the right wing wheel assembly; and
a third position sensor configured to monitor the third vertical position of the left wing wheel assembly.

13. The agricultural implement of claim 12, wherein the controller communicatively coupled to the first position sensor, the second position sensor, and the third position sensor.

14. The agricultural implement of claim 13, wherein the controller is configured to control the hydraulic circuit based on feedback from the first position sensor, the second position sensor, and the third position sensor.

15. A hydraulic circuit, comprising:
a main lift metering valve configured to receive pressurized hydraulic fluid from a hydraulic pump and to output the pressurized hydraulic fluid to raise and lower a height adjustment system for an agricultural implement, wherein the height adjustment system comprises a plurality of actuating cylinders; and
a wing control valve circuit comprising a first control valve, wherein the first control valve is configured to control fluid flow to and from a wing lift cylinder of the plurality of actuating cylinders, wherein the wing lift cylinder is configured to control a vertical position of a wing section wheel assembly independently of a center section wheel assembly.

16. The hydraulic circuit of claim 15, comprising an additional wing control valve circuit comprising a second control valve, wherein the second control valve is configured to control fluid flow to and from an additional wing lift cylinder of the plurality of actuating cylinders, wherein the additional wing lift cylinder is configured to control an additional vertical position of an additional wing section wheel assembly independently of the center section wheel assembly.

17. The hydraulic circuit of claim 15, wherein the wing control valve circuit comprises a first four-way, three-position, solenoid activated valve.

18. The hydraulic circuit of claim 15, wherein the wing control valve circuit comprises:
a compensator with a spring end, wherein the compensator is disposed along an input conduit to the first control valve; and
a shuttle valve configured to transfer a pressure from a rod end or a cap end of the wing lift cylinder to the spring end of the compensator, wherein the shuttle valve and the compensator are configured to create a substantially constant pressure differential across the first control valve.

19. The hydraulic circuit of claim 15, wherein the wing control valve circuit comprises:
a check valve configured to enable fluid flow from a first output valve conduit to a second output valve conduit, and normally block fluid flow from the second output valve conduit to the first output valve conduit; and
a pilot conduit fluidly coupled to the check valve, wherein the check valve is configured to open and enable fluid to flow from the second output valve conduit to the first output valve conduit in response to the pilot conduit being pressurized.

20. The hydraulic circuit of claim 15, comprising:
a first hydraulic fluid input configured to provide hydraulic fluid through a first supply conduit to the main lift metering valve; and
a second hydraulic fluid input configured to provide hydraulic fluid through a second conduit to the main lift metering valve.
